(19) United States
(12) Patent Application Publication
(10) Pub. No.: US 2006/0147103 A1
(43) Pub. Date: Jul. 6, 2006

(54) Device for identifying a structure to be applied to a substrate, and corresponding methods

(76) Inventors: Jan Anders Linnenkohl, Munchen (DE); Dubravico Srsan, Puchheim (DE); Witold Ganzke, Furstenfeldbruck (DE); Kenneth Weisheit, Stadtbergen (DE)

Correspondence Address: THE SMALL PATENT LAW GROUP LLP, 611 OLIVE STREET, SUITE1611, ST. LOUIS, MO, 63101, US

(21) Appl. No.: 10/533,804

(22) PCT Filed: Nov. 5, 2003
(86) PCT No.: PCT/EP03/12354

§ 371 Date: Nov. 14, 2005

(30) Foreign Application Priority Data
Nov. 5, 2002 (DE) 10251734.7
Nov. 11, 2002 (DE) 10252340.1

(51) Int. Cl. G06K 9/00

(52) U.S. Cl. 382/141

(57) ABSTRACT

A device and method are provided for the detection of a structure, preferably an adhesive extrusion line, to be applied to a substrate. The device includes an illumination module and a sensor unit. The sensor unit is provided on the facility that applies the structure. An analytical unit is provided which places a set of calipers over the set of data determined by the image elements, whereby the calipers preferably extend orthogonal to the track of the substrate structure. The structure is determined by based on the brightness profile of the gray values along the calipers. A second derivative of the profile of the gray values is used for structure determination. The structure determination is performed according to the following criteria: a. level of edge contrast; b. width of structure; c. difference between set vs actual position; e. difference between set vs actual width of the structure; g. difference between set vs actual brightness of the structure; i. difference between set vs actual brightness of the background.

### RELATED APPLICATION

The present application relates to and claims priority from PCT/EP2003/012354 filed Nov. 5, 2003, titled “DEVICE FOR THE DETECTION OF A STRUCTURE TO BE APPLIED TO A SUBSTRATE AND SUITABLE PERTINENT METHODS”, the complete subject matter of which is hereby expressly incorporated in its entirety.

### BACKGROUND OF INVENTION

The present invention generally relates to a device for the detection of a structure to be applied to a substrate, as well as suitable pertinent methods.

It has been conventional to perform optical measurements in order to detect a structure to be applied to a substrate, whereby often various systems for fully-automatic inspection of the structure, including adhesive and sealing agent extrusion lines, have been used. For this purpose, one or multiple video-cameras are trained on the structure to be detected. In addition, an illumination module is required whose purpose it is to generate a camera image that is rich in contrast. The inspection of the structure is performed in a delayed fashion, several seconds after application of the structure to the substrate. In many cases, the inspection is not performed until all of the structure is applied to the substrate. This is disadvantageous in that the inspection is performed separate and independent of the process of application, which may be tedious and difficult to handle in some of the cases. Hitherto, these systems were not stabile enough and to tedious in their parameterization to allow direct inspection.

### SUMMARY OF INVENTION

In certain embodiments, a device is provided for the detection of a structure to be applied to a substrate and suitable pertinent methods such that, on the one hand, direct inspection of the structure applied is feasible and, on the other hand, inspection is easy to perform.

Moreover, a device and method are provided for the detection of a structure to be applied to a substrate, including for subsequent inspection, such that, on the one hand, subsequent inspection is feasible in a simple fashion, and, on the other hand, an accurate error analysis for the structure to be applied is provided.

A sensor unit is provided on the facility for the application of the structure. By this means, a visual inspection system with a compact design is provided, whereby the illumination module can preferably also be provided on the facility for the application of the structure. This facilitates the integration of the device according to the present application into existing systems whose task it is to apply a structure to a substrate. While the structure is applied to the substrate, if an error is present, it is feasible to directly act or interrupt during the manufacturing process and/or sort out the defective substrate. This provides for improved efficiency in the manufacture of structures on a substrate. If the method involves a tested area of the structure that is placed along the structure to be tested by means of support points, the handling becomes trouble-free since the interactive process between the user and the displayed structure is implemented in a simple fashion with currently existing means. If, according to the invention, the range of tolerance is set along the reference line defined by the support points, inaccuracies of the structure, if any, will be accounted for and, in particular, the quality inspection of the structure to be tested can be set individually by this means. This simplified operator interaction allows even complex track profiles of the structure to perform a teach-in process in a simple and efficient fashion. Moreover, the existing display visualizing the structure and the reference line generated by the support points indicates directly to the user whether or not deviations in the track profile of the structure are present.

Further advantageous embodiments are the subject matter of the dependent claims.

By positioning the sensor unit directly at the exit of the facility for the application of the structure, it becomes feasible to provide a compact and highly-integrated implementation of the device. Therefore, the sensor unit is capable of fully automatic high-speed inspection of the structure almost directly after its application. The sensor unit comprises a video-sensor, and may use various image detection procedures. The video-sensor may comprise one and/or several picture lines, (e.g., 15 lines), such that a high image recording rate can be achieved. By this means the device stays small in size and the image analysis can be performed in the sensor unit such that no external data analysis facility is needed.

The use of a white light illumination module as illumination module allows the use of conventional halogen lamps also for the generation of white light. The use of an LED illumination module as illumination module allows for the provision sensor illumination for improved contrast between background and structure by skillfully combining different spectral ranges. The analysis as such can therefore proceed in a stabile fashion and the resource use involved in the analytical logics is minimized also. The same applies in particular to the provision of multiple illumination modules, which can therefore provide for improved contrast. If, in addition, the analytical unit is integrated in the sensor unit, it becomes easy to add to the device the feature of setting the quality criteria in a simple fashion by means of an external control unit. The transmission preferably is mediated by radio, infrared data or cable.

If the method used involves that the structure is determined by means of so-called calipers (gray edge scanning), which preferably extend orthogonal to the structure on the substrate, this means can be used to define specific areas, preferably crossing areas, between the caliper line and a contrast structure in the area to be determined. If the calipers extend orthogonal to the structure on the substrate, this allows especially the width of the structure to be determined in a simple fashion. In conjunction with appropriate visualization software, the profile of the structure and the corresponding areas of error can be displayed. The user thus recognizes immediately whether or not the profile of the structure complies with the given range of tolerance or if the structure is being applied inaccurately. Another advantage is provided by making it feasible to base the structure determination and corresponding error analysis for example on the given substrate data, such as recesses and elevations, since this allows more exact statements concerning the profile of the structure to be made.

It has proven to be advantageous to base the determination of structure on the analysis of the brightness profiles of the gray values along the caliper. Therefore, the gray values can be used to determine in which place an area to be determined is to be subjected to structure inspection; in particular it becomes feasible to determine a position, at which the change from object to background is the highest. This is achieved by using the second derivative of the gray value profile for structure detection. The values to be determined are determined exactly as sub-pixels. If a set of hypotheses is generated for each caliper, especially for the case of four nodes of the caliper, a set of six options of variation is obtained, which each differ by the distance of the positions of the individual nodes of the caliper.

By linking neighboring sets of hypotheses to each other, certain values can be assigned, especially through the use of a heuristic function, on the basis of which the relevant nodes for the edge of the structure can be determined.

Further advantageous refinements are the subject matter of the remaining dependent claims.

### BRIEF DESCRIPTION OF DRAWINGS

In the following, advantageous refinements of the invention shall be illustrated on the basis of the following drawings.

FIG. 1 shows schematically an advantageous embodiment of the device according to the invention.

FIG. 2 shows a sub-area of the structure applied in FIG. 1.

FIG. 3 shows an error analysis.

FIG. 4 shows the application of the calipers to an area to be defined, which contains both the structure and deviations.

FIG. 5 shows the crossing points of the relevant contrast lines and the caliper.

FIG. 6 shows the generation of a set of hypotheses from a caliper.

FIG. 7 shows the structure determination from neighboring sets of hypotheses.

FIG. 8 shows the method for the determination and/or elimination of deviated edges and/or determination of the structure.

### DETAILED DESCRIPTION OF EMBODIMENTS

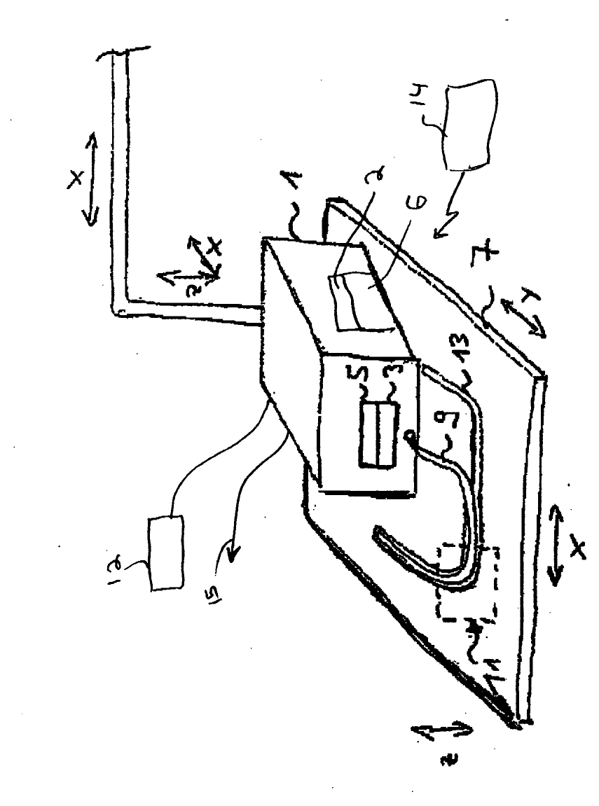

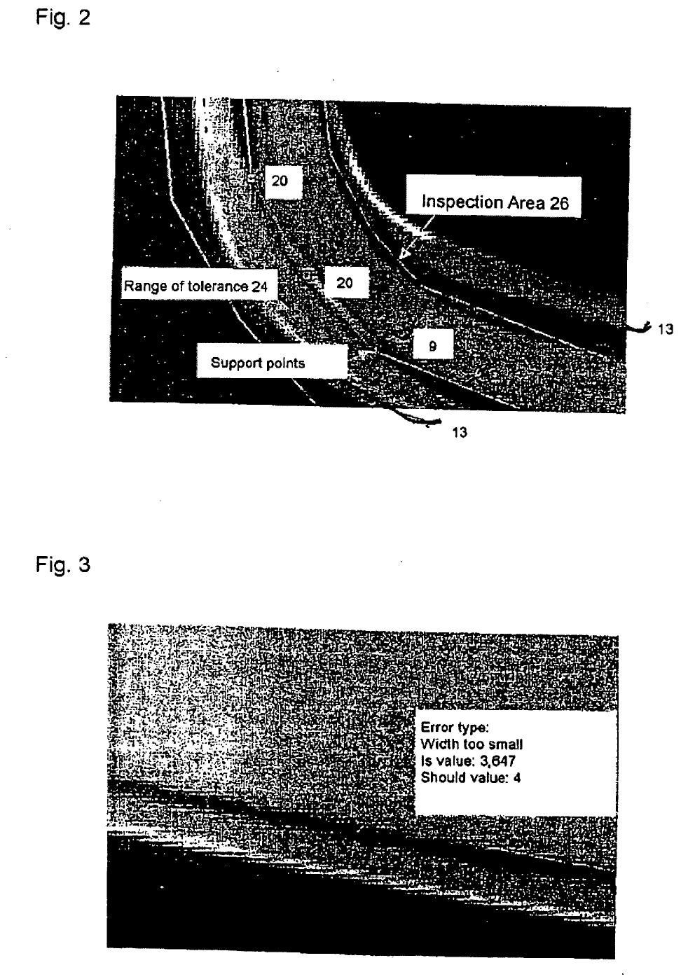

FIG. 1 shows a device 1 for the application of a structure 9, such as an adhesive extrusion line, to a substrate 7. The position of device 1 is adjustable in x, y, and z direction. Optionally, the device may be fixed in position and the substrate may be adjustable in x, y, and z direction. The device 1 further comprises a sensor unit 3 (e.g., a video sensor), which, in this embodiment, is positioned directly at the exit of the device 1 for the application of the structure. Also shown in this schematic drawing is the illumination module 5, which provides for the contrast during the application and/or registration of the areas to be monitored. It can be seen in this embodiment that a so-called adhesive extrusion line 9 is being applied to and/or introduced into a pre-made recess 13 in the substrate 7. Reference number 11 shows by shaded lines an area of the image shown in more detail in FIG. 2.

The device 1 includes an analytic unit 6 (e.g., processor) that communicates with the sensor unit 3 and memory 2. The sensor unit 3 obtains video or still images of the area 11 of the substrate 7 and line 9. The images are stored in memory 2 and/or displayed on monitor 12 (e.g., a 3D display). The analytic unit 6 determines sets of data from the images, where the sets of data correspond to the structure 9 on the substrate 7. The analytic unit 6 may be controlled by an external control unit 14 (e.g., an infrared data transmission), used to set quality criteria. The analytic unit 6 may include visualization software.

Optionally, a network connection 15 may provide trigger and analysis over the internet or an intranet.

FIG. 2 shows, for example, the recess 13 into which the structure and/or adhesive extrusion line 9 is introduced. This selected area can be processed in the analytical unit 6 in the sensor unit 3, or it can, as a matter of principle, be displayed to the user right during the application process such that the user can manually set his support points 20 on the basis of which a reference line 22 can be generated. As is clearly evident from FIG. 2, a range of tolerance is defined with regard to the reference line 22, which approximately reflects the course of the structure, which range of tolerance in this case is equidistant to the reference line. Accordingly, it is being tested whether or not the reference line defined by the support points is within the range of tolerance. In addition to the range of tolerance, FIG. 2 shows an inspection area 26, in which the structure is situated.

FIG. 3 shows an error display, for example, which does not only identify the position of the error in the application of the structure, but also indicates the magnitude of the error to the user based on the analytical accuracy of the method according to the invention. The user can then decide on the basis of the magnitude of the error whether or not the deviation from the set value is tolerable or if the manufacturing process needs to be terminated. Accordingly, the method allows to make a decision on the basis of direct inspection of the application of the structure in the course of the manufacturing process, in a fully automatic fashion, as to whether or not the manufacturing process needs to be interrupted and/or if the defective substrate needs to be sorted out.

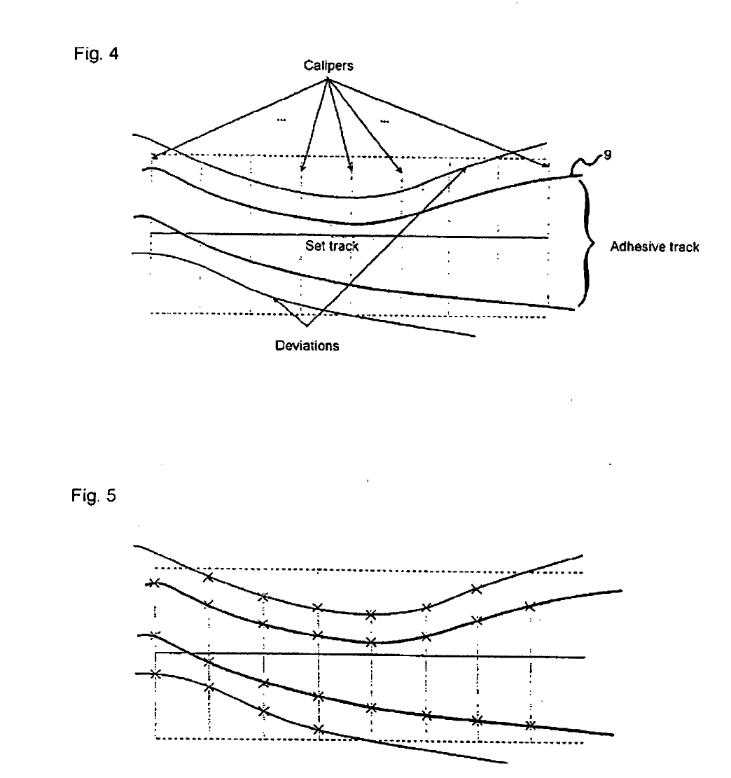

The analytical procedure is described in the following by FIGS. 4 to 8. FIG. 4 shows the so-called edge extraction of the features present in the inspection area. For this purpose, a set of calipers, which preferably extend orthogonal to the track of the structure, is placed over the inspection area, whereby the extraction of the edges thus proceeds orthogonal to the track of the structure due to the analysis of the brightness profile of the gray values. This determines a position reflecting the change from object to background, in which this change is most pronounced. This is achieved by calculating the second derivative of the profile of the gray values. The values to be determined are thus determined at sub-pixel accuracy.

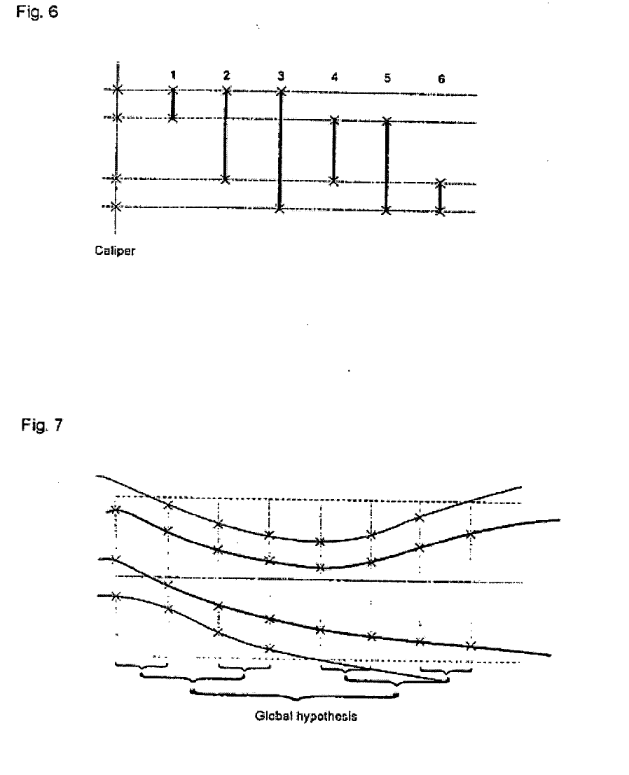

FIG. 5 shows the tracing of the structure's track after edge extraction, whereby all edges found for each line by means of the node points are shown.

FIG. 6 shows that a set of hypotheses is generated for each caliper of FIGS. 4 and 5, whereby, for example, for four node points of a caliper a total of six position hypotheses are exist. Subsequently, the caliper hypotheses are gradually, preferably in a hierarchical fashion, linked to the corresponding neighbor and/or neighboring sets of hypotheses. This linkage is performed in an iterative fashion, as shown in FIG. 7. For this purpose, left and right hypotheses are generated progressively, which in turn are linked to each other and/or analyzed using a heuristic function. One selection criterion for defining the determination of structure can, for example, be ‘the higher the value determined, the better is the underlying hypothesis’.

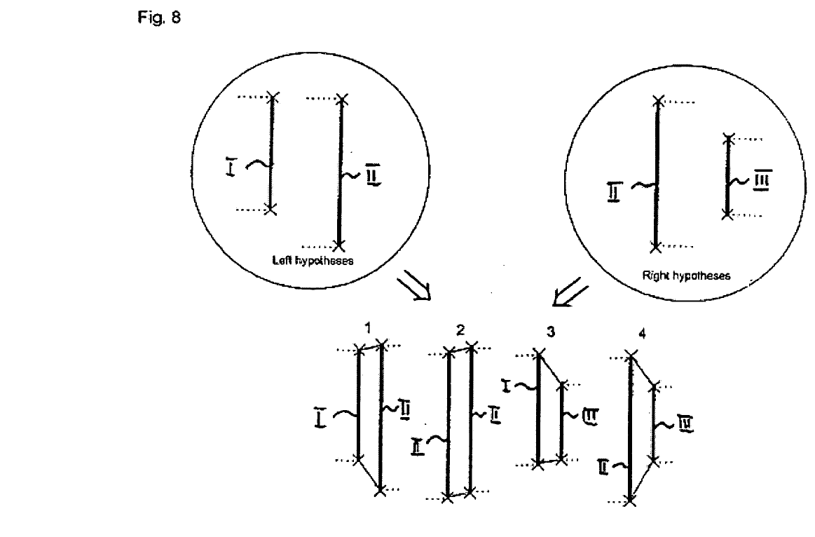

FIG. 8 clearly illustrates how the iterative procedure of the individual sets of hypotheses is applied. In the process, for example the sets of hypotheses, 2, 3, 4 in FIG. 6 (I-II, I-III, II-III, II-II) are linked in a combinatorial fashion, whereby in each case the left hypothesis of hypothesis 3 is linked to the corresponding right hypothesis. This in turn results in an assignment of the hypotheses, whereby a value is determined on the basis of the heuristic function. Because of the pre-determined rule, according to which “the higher the value, the better is the hypothesis”, the structure can then be determined by eliminating the hypotheses with a lower value according to the heuristic function if the number of hypotheses thus developed exceeds the permissible number of hypotheses per existing node.

These methods can be used to determine the structure precisely and accurately and with few sets of data such that direct a determination of the structure, for example during the application of the structure, is feasible. It should be noted in this context that the heuristic function uses the following criteria to determine the set value.

1. Level of edge contrast

2. Width of structure

3. Difference between set vs actual position

4. Co-linearity of the actual position

5. Difference between set vs actual width of the structure

6. Co-linearity of the actual width of the structure

7. Difference between set vs actual brightness of the structure

8. Co-linearity of the actual brightness of the structure

9. Difference between set vs actual brightness of the background

10. Co-linearity of the actual brightness of the background

Based on the actual implementation, according to which the device is used during the application of an adhesive extrusion line to a substrate, it is advantageous to comply with the following: according to an advantageous embodiment, the system and/or device according to the invention consists essentially of a color line video-sensor with an integral analytical unit and illumination for imaging and illumination of the sealing agent and/or adhesive extrusion line. The components reside in a compact protective housing. The visual inspection system is attached directly downstream from the adhesive application system (application nozzle) and is trained on the area shortly downstream from the adhesive nozzle in order to perform a test directly after the application of the extrusion line. The test is therefore performed directly after the application of the sealing agent or adhesive allowing the quality of the extrusion line to be analyzed (for breaks, position and placement, thickness) while it is being applied.

A video-sensor records only one or several picture lines (maximally 15 lines) in order to achieve a high image recording rate. The analysis is performed in the color line video-sensor with an integral analytical unit. An external data analysis facility (analytical PC) is not required, since the video-sensor itself includes a miniaturized analytical computer. The quality criteria (IO/NIO limit values) are set by means of an external control unit connected to the sensor via a radio connection, infrared data transmission connection (IrDa) or cable connection (serial or network).

Depending on the surface properties of the adhesive and/or sealing agent, one/several
white light illumination module(s), e.g. halogen lamp(s), and/or
LED illumination module(s) with various colors are used to illuminate the track of the adhesive structure.

The illumination modules are compact in design to allow them to be installed in a compact system (image recording sensor and illumination in a joint housing). For this purpose, provision are made for combining various different illumination modules (differing in structural shape, color) in order to achieve high contrast between background and adhesive by suitably combining different spectral ranges of illumination and sensor. Accordingly, the analysis can proceed in a stabile fashion and the resource use required for the analytical logics can be kept low. The illumination module contains a white light illumination module. The illumination module may include a LED illumination module radiating the spectral ranges, red, blue, green, infrared and/or ultraviolet.

The purpose of the visualization software is to display errors made during the application of extrusion lines of adhesive. For this purpose, the adhesive track to be traced is stored as a 3D track and the corresponding error areas are marked therein. The corresponding errors are highlighted through the use of a different color and labeled with additional text. The software and/or sensor communicates with a robot or any other control unit using any of the common field buses (Profibus, Interbus, Devicenet), Ethernet, serial interface, OPC—server or any other available communication interfaces. In the offline version, the robot track is programmed and stored ahead of time. After the process of adhesive application, the visualization software can be triggered and then obtains the respective error areas from the robot. In the online version, the visualization software is provided at all times during the run with the current position along the robot's track and, if there is an error, with an error code.

In addition, data can be accepted from CAD files. The data of the component contained therein, i.e. the adhesive track or similar data, can be co-processed and displayed jointly with the corresponding error sites in a 3-dimensional or 3-dimensional display.

In order to simplify the user interaction, a GUI special-developed for the inspection of adhesive tracks was used. Simple mouse clicks can be used to enter complex track profiles in a simple and efficient fashion. The graphical elements are designed such that the set limit values, such as min/max ranges and range of tolerance are easy to see (FIG. 2). Changes in the track of the profile can also be made with just a few mouse clicks. In this context, there is no need to enter the adhesive track exactly, since the downstream image processing operations are sufficiently stabile to compensate for the inaccuracies generated during input of the information. An additional display provides the operator with information concerning any production errors. By clicking on an error with the mouse, the respective area is enlarged and the plain text description of the error is displayed (FIG. 3).

The mathematical linkage shown in the following is used to determine the heuristic function for the structure determination, i.e. a heuristic value for elementary hypotheses and a heuristic value for complex hypotheses.

A. Heuristic Value for Elementary Hypotheses

The following applies to an input vector:
\overline{x}={x_{weight1},x_{weight2},xₚₒₛ₁,xₚₒₛ₂,x_{br},x_{bk}},
wherein:
x_{weight1} weight of the first point,
x_{weight2} weight of the second point,
xₚₒₛ₁ position of the first point,
xₚₒₛ₂ position of the second point,
x_{br} brightness of the structure,
x_{bk} brightness of the background,

The following applies to the set values:
\overline{s}={s_{width},s_{br},s_{bk}}
wherein:
s_{width} set width,
s_{br} set brightness of the structure,
s_{bk} set brightness of the background,
   with the heuristic coefficients:
   \overline{a}={a_{const},a_{weight},aₚₒₛ,a_{width},a_{br},a_{bk}}
   \overline{b}={bₚₒₛ,b_{width},b_{br},b_{bk}}

The heuristic value, h, takes the following form:

$$h ( \overline{a} , \overline{b} , \overline{x} , \overline{s} ) = {a}_{const} + {( {a}_{weight} \cdot {x}_{weight 1} )}^{{b}_{weight}} + {( {a}_{weight} \cdot {x}_{weight 2} )}^{{b}_{weight}} - {( {a}_{pos} \cdot {e}_{pos} )}^{{b}_{pos}} - {( {a}_{width} \cdot {e}_{width} )}^{{b}_{width}} - {( {a}_{br} \cdot {e}_{br} )}^{{b}_{br}} - {( {a}_{bk} \cdot {e}_{bk} )}^{{b}_{bk}} , \\ wherein \text{:}$$

$${e}_{pos} = abs ( \frac{{x}_{pos 1} + {x}_{pos 2}}{2} ) , \\ {e}_{width} = abs ( {x}_{pos 2} - {x}_{pos 1} - {s}_{width} ) , \\ {e}_{br} = abs ( {x}_{br} - {s}_{br} ) , \\ {e}_{bk} = abs ( {x}_{bk} - {s}_{bk} ) .$$

B. Heuristic Value for Complex Hypotheses

The following applies to an input vector:
\overline{x}={xₗₚₒₛ,x_{lwidth},x_{lbr},x_{lbk},xᵣₚₒₛ,x_{rwidth},x_{rbr},x_{rbk}},
wherein:
xₗₚₒₛ position on the right side of the left hypothesis,
x_{lwidth} width on the right side of the left hypothesis,
x_{lbr} brightness of the structure on the right side of the left hypothesis,
x_{lbk} brightness of the background on the right side of the left hypothesis,
xᵣₚₒₛ position on the left side of the right hypothesis,
x_{rwidth} width on the left side of the right hypothesis,
x_{rbr} brightness of the structure on the left side of the right hypothesis,
x_{rbk} brightness of the background on the left side of the right hypothesis,
   with the heuristic coefficients:
   \overline{a}={a_{const},aₚₒₛ,a_{width},a_{br},a_{bk}}
   \overline{b}{bₚₒₛ,b_{width},b_{br},b_{bk}}

The heuristic value, h, takes the following form:
h(\overline{a},\overline{b},\overline{x},\overline{s})=a_{const}+h_{left}+h_{right}−(aₚₒₛ·eₚₒₛ)^{b}^{ₚₒₛ}−(a_{width}·e_{width})^{b}^{_{width}}−(a_{br}·e_{br})^{b}^{_{br}}−(a_{bk}·e_{bk})^{b}^{_{bk}},
wherein:
eₚₒₛ=abs(xₗₚₒₛ−xᵣₚₒₛ),
e_{width}=abs(x_{lwidth}−x_{rwidth}),
e_{br}=abs(x_{lbr}−x_{rbr}),
e_{bk}=abs(x_{lbk}−x_{rbk}).
and
h_{left} heuristic value of left hypothesis
h_{right} heuristic value of right hypothesis

1. A device for detecting a structure, to be applied to a substrate, comprising:
an illumination module;
a sensor unit, the sensor unit being provided on a device that applies the structure to the substrate, the sensor unit obtaining an image of an area of the substrate; and
an analytical unit placing a set of calipers over a set of data determined from the image, whereby the calipers extend at a non-parallel angle to a track upon the substrate, the image illustrating structure through a brightness profile of gray values along the calipers, the analytic unit performing structure determination according to at least one of the following criteria:
a. Level of edge contrast;
b. Width of structure;
c. Difference between set vs actual position;
e. Difference between set vs actual width of the structure;
g. Difference between set vs actual brightness of the structure; and
i. Difference between set vs actual brightness of the background.

2. The device according to claim 1, wherein the sensor unit is positioned directly at the exit of the facility for the application of the structure.

3. The device according to claim 1 wherein the sensor unit comprises a video-sensor which records one and/or several picture lines.

4. The device according to claim 1 wherein the illumination module contains a white light illumination module.

5. The device according to claim 1 wherein the illumination module is an LED illumination module radiating the spectral ranges, red, blue, green, infrared and/or ultra-violet.

6. The device according to claim 1 further comprising multiple illumination modules.

7. The device according to claim 1 wherein the analytical unit is provided within the sensor unit, whereby the quality criteria are set by means of an external control unit.

8. The device according to claim 1 wherein the analytical unit generates a set of hypotheses for each caliper.

9. The device according to claim 8, wherein the analytical unit links neighboring sets of hypotheses.

10. Device according to claim 1 wherein the analytical unit performs the structure determination, in addition, according to at least one of the following criteria:
d. Co-linearity of the actual position;
f. Co-linearity of the actual width of the structure;
h. Co-linearity of the actual brightness of the structure; and
j. Co-linearity of the actual brightness of the background.

11. Device according to claim 1 further comprising a three-dimensional display made possible by means of the position of the sensor unit and the structure determination.

12. Device according to claim 1 further comprising a network connection that provides triggering and analysis over one of the Internet or Intranet.

13. A method for the detection of a structure applied to a substrate, comprising:
a) providing an illumination module and a sensor unit on the device that applies the structure to the substrate;
b) determining the structure during the application of the structure to the substrate, whereby the structure determination is performed by means of calipers, which extend non-parallel to a track of the substrate and structure; and
displaying a profile of the structure, and corresponding error areas; whereby the structure determination is performed by means of the analysis of the brightness profile of the gray values along the caliper according to at least one of the following criteria:
a. Level of edge contrast
b. Width of structure
c. Difference between set vs actual position
e. Difference between set vs actual width of the structure
g. Difference between set vs actual brightness of the structure
i. Difference between set vs actual brightness of the background

14. The method according to claim 13, whereby the structure determination is performed with at least one illumination module being a white light module and/or an LED illumination module with different colors.

15. The method according to any one of the claim 13, whereby substrate data are used for structure determination and corresponding error analysis.

16. The method according to claim 13, whereby different error areas can be displayed separately by the visualization software.

17. The method according to claim 13, whereby the structure determination, in addition, is performed according to at least one of the following criteria:
d. Co-linearity of the actual position
f. Co-linearity of the actual width of the structure
h. Co-linearity of the actual brightness of the structure
j. Co-linearity of the actual brightness of the background

18. A method for the detection of an adhesive extrusion line applied comprising:
a) Obtaining an image showing the structure to be detected;
b) Placing support points along the structure to be detected;
c) Connecting the support points to generate a reference line; whereby, in addition, an inspection area along the reference line is defined;
d) Defining a range of tolerance along the reference line;
e) Determining whether or not the structure is within the range of tolerance; and
placing a set of calipers over a set of data in the image, the structure being determined by means of the brightness profile of the gray values along the calipers.

19. The method according to claim 18, are generated a set of hypotheses for each caliper.

20. The method according to claim 19, wherein neighboring sets of hypotheses are linked.

21. The method according to claim 18, whereby the structure determination, is performed according to at least one of the following criteria:
a. Co-linearity of the actual position,
b. Co-linearity of the actual width of the structure,
c. Co-linearity of the actual brightness of the structure,
d. Co-linearity of the actual brightness of the background.

22. The method of claim 18, further comprising generating a set of hypotheses for the calipers, and linking neighboring sets of hypotheses.

23. The method of claim 18, wherein the structure determination is performed according to at least one of the following criteria:
a. Level of edge contrast;
b. Width of structure;
c. Difference between set vs actual position;
d. Difference between set vs actual width of the structure;
e. Difference between set vs actual brightness of the structure; and
f. Difference between set vs actual brightness of the background.
